(19) United States
(12) Patent Application Publication
(10) Pub. No.: US 2026/0093340 A1
(43) Pub. Date: Apr. 2, 2026

(54) LOW POWER GESTURE DETECTION

(71) Applicant: Apple Inc., Cupertino, CA (US)

(72) Inventors: Nurul Islam, Mountain View, CA (US); Dan Nussinson, Haifa (IL); Jack E. Graves, Sunnyvale, CA (US); Jack Schulze, Los Altos, CA (US); Michael C. Wharton, San Jose, CA (US); Ryan J. Dunn, Santa Cruz, CA (US); Jonathan A. Topf, London (GB); Ethan T. Daniels, Los Gatos, CA (US); Joseph A. Malia, London (GB)

(21) Appl. No.: 19/342,431

(22) Filed: Sep. 26, 2025

Related U.S. Application Data
(60) Provisional application No. 63/700,578, filed on Sep. 27, 2024.

(51) Int. Cl. G06F 3/01; G01S 17/50; G01S 17/88

(52) U.S. Cl. CPC G06F 3/017; G01S 17/50; G01S 17/88

(57) ABSTRACT

Embodiments are disclosed for low power gesture detection using FMCW signals. In some embodiments, a method comprises: emitting, by a frequency modulated continuous wave (FMCW) sensor, an FMCW signal into an environment; receiving, by the FMCW sensor, a reflected FMCW signal from a target in the environment; processing, by the FMCW sensor, the reflected FMCW signal by: generating a time-frequency representation of the reflected FMCW signal; detecting at least one tap gesture from the time-frequency representation; and controlling, with at least one processor, a first operation of a device in response to the detected at least one tap gesture. In some embodiments, the FMCW sensor is further configured to detect a twist gesture from the time-frequency representation and control a second operation of the device in response to the detected twist gesture.

### CROSS-RELATED APPLICATION

This application claims the benefit of priority to U.S. Provisional Application No. 63/700,578 for “Low Power Gesture Detection,” filed Sep. 27, 2024, which provisional application is incorporated by reference herein in its entirety.

### TECHNICAL FIELD

This disclosure relates generally to gesture detection using frequency modulated continuous wave (FMCW) signals.

### BACKGROUND

Detecting gestures using cameras is challenging because each frame consumes a large amount of energy (e.g., 1.5 millijoules (mJ) of energy). For example, detecting a hand gesture using a neural processing unit (NPU) consumes 10 seconds of milliwatt (mW) of power, and detecting a pinch gesture requires a high frame rate and hand joint detection, both of which are power consuming.

### SUMMARY

Embodiments are disclosed for low power gesture detection using FMCW signals.

In some embodiments, a method comprises: emitting, by a continuous wave (FMCW) sensor, a FMCW signal into an environment; receiving, by the FMCW sensor, a reflected FMCW signal from a target in the environment; processing, by the FMCW sensor, the reflected FMCW signal by: generating a time-frequency representation from the reflected FMCW signal; detecting at least one tap gesture from the time-frequency representation; and controlling, with at least one processor, a first operation of a device in response to the detected at least one tap gesture.

In some embodiments, detecting at least one tap gesture from the time-frequency representation, further comprises: determining a rate of change of a beat signal phase over time from the time-frequency representation; detecting a shift in the rate of change of the beat signal phase over time; comparing the shift to a threshold; and detecting the at least one tap gesture based on a result of the comparing.

In some embodiments, processing the reflected FMCW signal further comprises: detecting a twist gesture from the time-frequency representation; and controlling, with the at least one processor, a second operation of the device in response to the detected twist gesture.

In some embodiments, detecting a twist gesture from the time-frequency representation further comprises: detecting ranges of the target from the time-frequency representation; detecting a change in the range over time; comparing the change to a threshold; and detecting the twist gesture based on a result of the comparing.

In some embodiments, the method further comprises: detecting if a hand is within a threshold distance of the FMCW sensor; responsive to the hand being within a threshold distance of the FMCW sensor, detecting a first tap gesture; detecting a second gesture following the first tap gesture; responsive to the second gesture being another tap gesture, performing the first operation of the device; and responsive to the second gesture being a twist motion, performing the second on operation of the device.

In some embodiments, the device includes a media player and the first operation selects audio content for playback on the device, and the second operation changes a volume of the audio content during the playback.

Other embodiments are directed to an apparatus, system and computer-readable medium.

Particular embodiments described herein provide one or more of the following advantages. Gesture detection using FMCW signals is less power consuming than, e.g., machine learning inference models, and also provides faster detection speed, which decreases latency in gesture detections, resulting in an improved user experience with applications that utilize gesture detection.

### BRIEF DESCRIPTION OF THE DRAWINGS

FIGS. 1A-1D illustrate using gestures to initiate actions on a device, according to one or more embodiments.

FIG. 2 is a conceptual block diagram of a system for implementing low power gesture detection, according to one or more embodiments.

FIG. 3 illustrates a system for transmitting and receiving FMCW signals, according to one or more embodiments.

FIGS. 4A and 4B are example time-frequency representations derived from reflected FMCW signals, according to one or more embodiments.

FIGS. 5A and 5B are plots showing detection of single tap, double tap and twist gestures from return FMCW signals, according to one or more embodiments.

FIG. 6 illustrates how a twist gesture can be detected, in accordance with one or more embodiments.

FIG. 7 illustrates using a machine learning model to predict tap or no tap classes based on various features of the return FMCW signal, according to one or more embodiments.

FIG. 8 illustrates a process for controlling operations of a device based on detected gestures, according to one or more embodiments.

FIG. 9 illustrates a process of low power gesture detection using FMCW signals, according to one or more embodiments.

FIG. 10 is a block diagram of an example device architecture for implementing the features and processes described in reference to FIGS. 1-9.

FIG. 11 illustrates an alternative embodiment for low power gesture detection using FMCW signals, according to one or more embodiments.

FIG. 12 is a flow diagram of an alternative process for low power gesture detection using FMCW signals, according to one or more embodiments.

### DETAILED DESCRIPTION

The disclosed embodiments implement low power gesture detection using FMCW signals. A FMCW sensor emits FMCW signals at a frequency that continuously increases or decreases over a defined frequency bandwidth, which is referred to as frequency modulation, sweep or chirp. The frequency is usually modulated in a linear manner. The duration of the recurring frequency modulation is called chirp time. The frequency modulation is typically triangular modulation or sawtooth modulation. The FMCW signal continuously increases from a minimum to a maximum frequency (up chirp) in a particular band. If the emitted FMCW signal hits a target, it will totally or partly reflect the signal back to the FMCW sensor. The reflected FMCW signal has a different frequency than the emitted FMCW signal. From the frequency shift of the two signals, the FMCW sensor can measure the range to and the radial velocity of the target.

At the FMCW sensor, the reflected time domain FMCW signal is divided into segments (e.g., of equal length and possibly overlapping) and a frequency transform is applied to each segment, transforming the data from the time domain representation to a time-frequency representation including both amplitude and phase. In some embodiments, a short term Fourier transform (STFT) partitions the time-domain reflected FMCW signal into several disjointed or overlapped segments by multiplying the signal with a window function and applying a Fast Fourier Transform (FFT) to each segment. The STFT is a function of time and frequency that indicates how the spectral content of a signal evolves over time. After the STFT, the signal is proportional to velocity as a function of time. In some embodiments, a complex-valued, 2-D array stores the results of windowed Fourier transforms, referred to as STFT coefficients. The amplitudes of the STFT coefficients form an amplitude time-frequency spectrum, and the phases of the STFT coefficients form a phase time-frequency spectrum.

A phase tracking process is applied to the phase time-frequency spectrum to track the derivative of the phase (dφ_{b}(t)/dt or “delta phase”) of the beat signal. The delta phase of the beat signal shifts in response to the end of a tap gesture when the user's thumb and a forefinger make physical contact. This delta phase shift is detectable by the phase tracking process which searches for and extracts the maximum delta phase shift from the phase time-frequency spectrum. The maximum delta phase shifts of two concurrent return channels are used to detect whether there is a tap or not. After a gesture detection, various actions can be performed on one or more devices that are associated with the gesture, such as contactless control of a device (e.g. a virtual reality (VR)/augmented reality (AR) goggles or glasses, an audio device (e.g., earbuds, headphones), appliances, etc.).

Some examples of gestures that can be detected with the embodiment described above include but are not limited to: single-tap, double-tap, and tap and twist. Other gestures are also possible, such as cupping (e.g., trigger engagement with wearable device), pinch/tap (e.g., control start/stop operation of a function of a device), double pinch/tap (e.g., control selection of media content), tap and drag (inward) (e.g., control forward/rewind/volume operations on media content), translation, slide and motion of individual fingers and hand wave (e.g., control noise cancellation, transparency operations or share media content). Other applications include nutrition application for jaw movement tracking, head motion tracking on a moving platform for spatial audio applications, silent interaction with extremely low volume voice recognition by emitting the FMCW signal into the ear canal and measuring the vibrations of the vocal cord or emitting the FMCW signal outward towards the vocal cord.

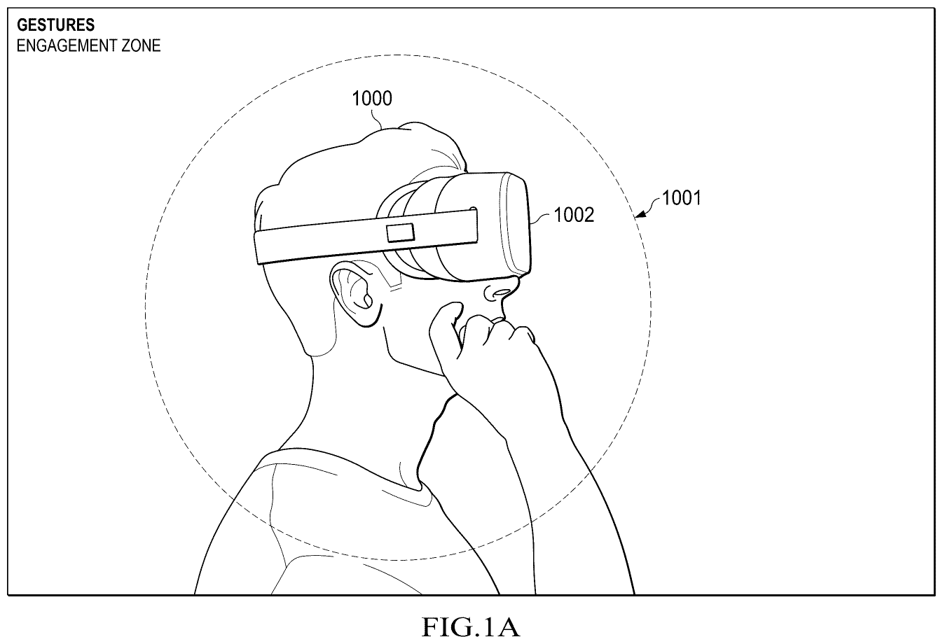

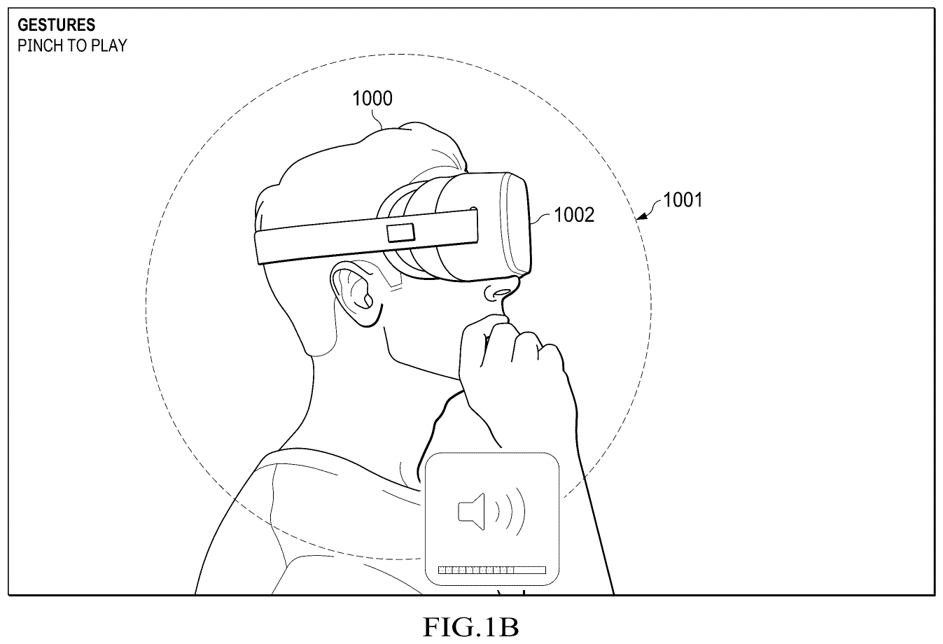

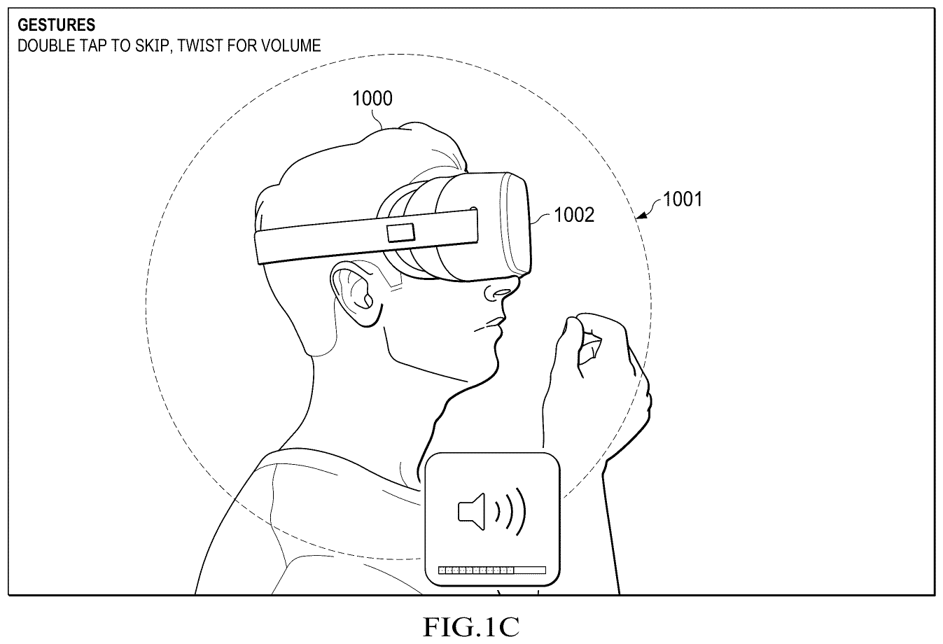

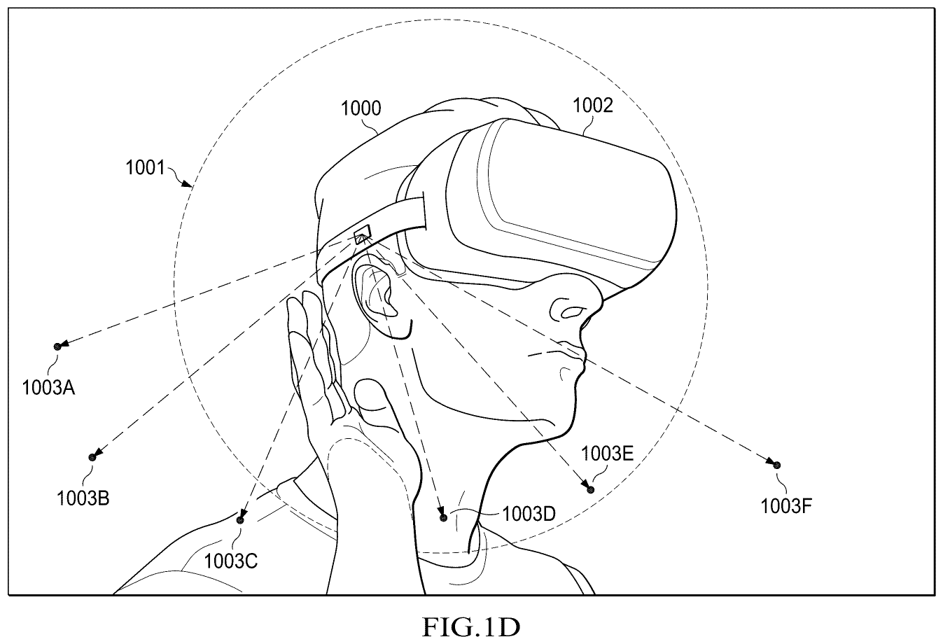

FIGS. 1A-1E illustrate using gestures to initiate actions on a device, according to one or more embodiments. Referring to FIGS. 1A and 1B, user 1000 is wearing VR goggles 1002 and performing a tap gesture. FMCW emitters embedded in VR goggles 1002 emit FMCW signals into a three-dimensional (3D) virtual engagement zone 1001 around the user's upper body (e.g., from the shoulders up). Engagement zone 1001 represents the coverage area of the FMCW sensor. Any gestures made by user 1000 within engagement zone 1001 will reflect the FMCW signals back to FMCW receivers in the FMCW sensor, where the reflected FMCW signals are processed for gesture detection, as described in further details below.

Referring to FIG. 1C, user 1000 is performing a twist gesture within engagement zone 1001, which is detected by the FMCW receivers embedded in VR goggles 1002. In some embodiments, the twist gesture can control the volume of audio generated by VR goggles 1002: clockwise to increase volume and counterclockwise to decrease volume or vice-versa.

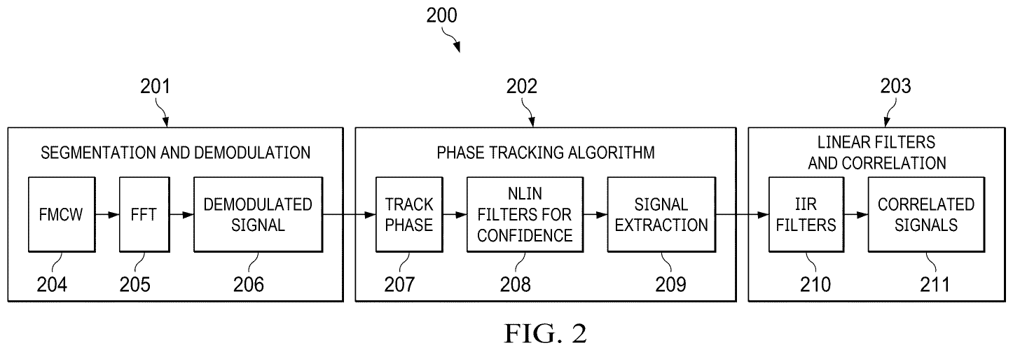

FIG. 1D illustrates the coverage area by the FMCW sensor in the engagement zone 1001, which is shown as vectors 1003a-1003f. One or more of the emitted FMCW signals will be reflected off the hand of user 1000 when user 1000 gestures within engagement zone 1001 and received by the receivers in the FMCW sensor. One or more processors embedded in VR goggles 1002 will process the reflected FMCW signals as described in reference to FIG. 2. In some embodiments, a single FMCW sensor includes a plurality of emitters and receivers to project a spot every x degrees (e.g., multiple vertical layers of N laser spots (e.g., N=36) at X degree separation (e.g., X=12 or13 degrees)), which is sufficient to cover the user's whole hand or some part of the hand when in engagement zone 1001 near the user's head.

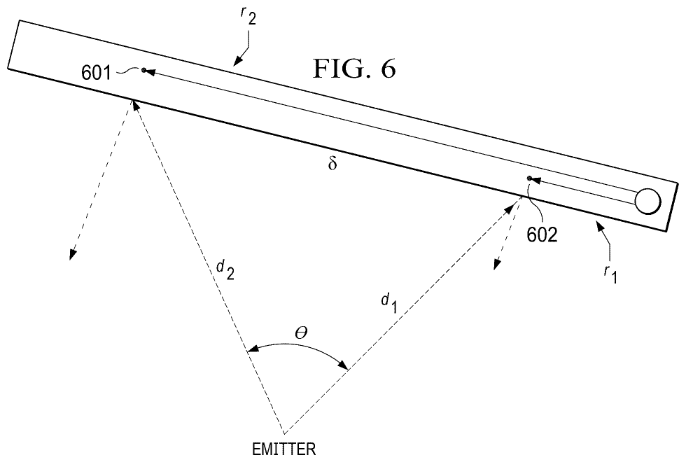

In some embodiments, the FMCW sensor includes a plurality of receivers associated with the plurality of emitters that are scanned by a process every 1 seconds (e.g., every 1 second). The ranges can be compared and the two closest ranges can be used for gesture detection. Using two laser spots allows for detecting twist motion and described in reference to FIG. 6. Also, the reflected signals from two laser spots can be correlated to determine if there is a signal present or uncorrelated noise.

Although in the description above, user 1000 is wearing VR goggles, the disclosed embodiments are applicable to any contactless device where gestures are used to control one or more operations of the device or another device, including but not limited to VR, augmented reality (AR) or mixed reality goggles or glasses, headphones, earbuds, appliances, game consoles, kiosks, etc.

FIG. 2 is a conceptual block diagram of system 200 for implementing low power gesture detection using FMCW signals, according to one or more embodiments. System 200 shows a signal processing path for reflected FMCW signals that includes segmentation and demodulation block 201, phase tracking block 202 and linear filters and correlation block 203.

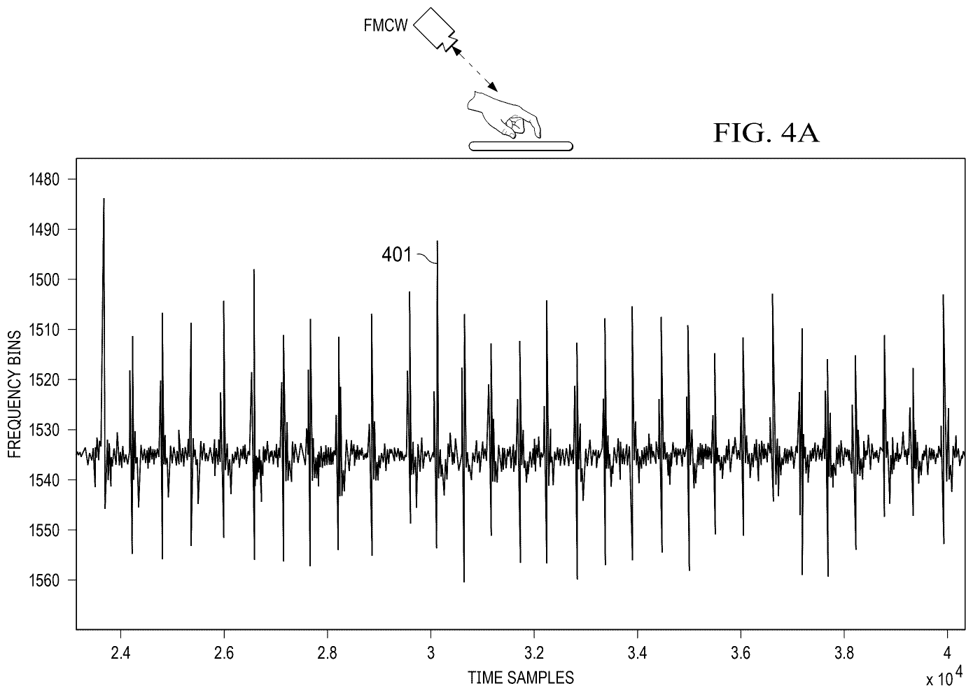

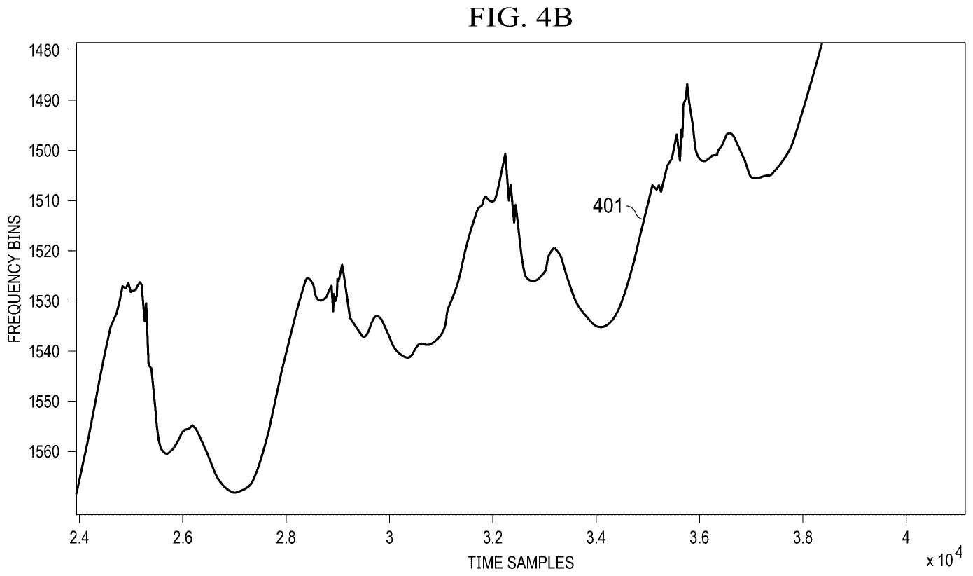

Segmentation and demodulation block 201 partitions the time-domain reflected FMCW signal into several disjointed or overlapped segments by multiplying the signal with a window function (kernel) and applying a Fast Fourier Transform (FFT) 205 to each segment each ramp of a sawtooth function. In some embodiments, a complex-valued, two-dimensional (2D) array stores the results of windowed Fourier transforms, referred to as coefficients. The magnitudes of the coefficients form a magnitude time-frequency spectrum, and the phases of the coefficients form a phase time-frequency spectrum. FIG. 4A shows an example time-frequency plot of the complex values (amplitude and phase).

Phase tracking block 202 applies a phase tracker process to each column of the 2D array of complex values to search for maximum delta phase shifts which are indicative of tap gestures. In some embodiments, the maximum delta phase shifts can be detected over time by comparing the delta phase to a specified threshold value for each column in the 2D complex valued array. If the delta phase meets or exceeds the threshold value, the detected maximum peak is high-passed filtered 208 for confidence testing (e.g., using non-linear filters). If the detected maximum delta phase shift passes the confidence test, the delta phase shift is extracted 209 from the 2D array. Consecutive extracted maximum delta phase shifts are input into an infinite impulse response (IIR) filter 210 to determine if the delta phase shifts are correlated 211, for example, to detect a double tap or uncorrelated noise.

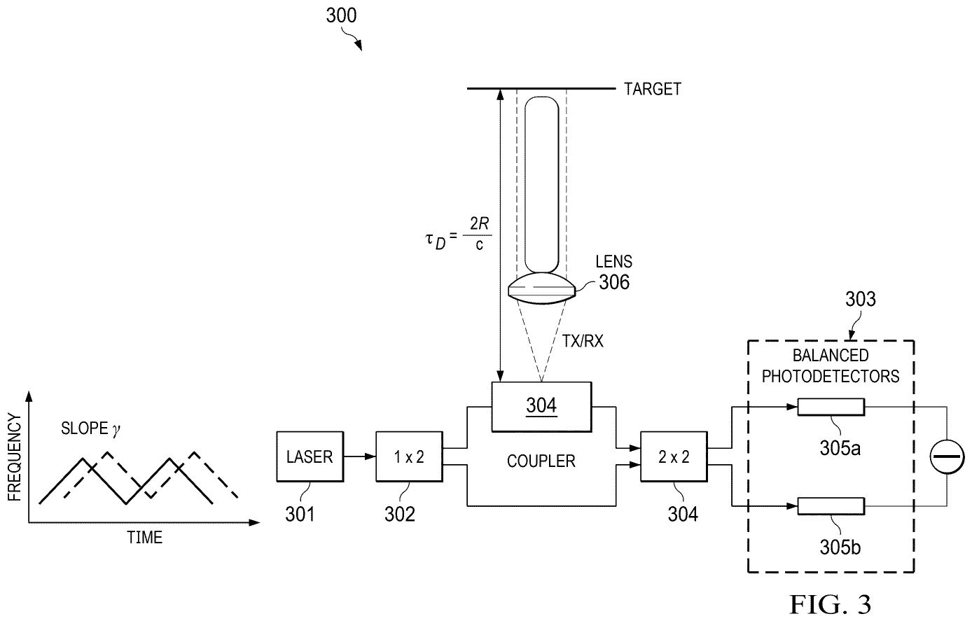

FIG. 3 illustrates an optical frequency modulation system 300 for transmitting and receiving FMCW signals, according to one or more embodiments. The optical output frequency of laser 301 is modulated and the outgoing light wave is divided into two parts by 1×2 optical coupler 302. One part is transmitted through lens 306 towards the target and the second part is used as a local oscillator signal by balanced photodetectors 303. In some embodiments, a self-mixing VCSEL array is used.

In some embodiments, balanced photodetectors 303 perform differential photodetection for detecting small differences in optical power between two optical input signals while suppressing any common fluctuation of the inputs (common mode rejection). In other embodiments, a single photodetector is used. In some embodiments, balanced photodetectors 303 include a 2×2 optical coupler 304 and a pair of photodetectors 305a, 305b to measure the intensities of both the sum and the difference of the local oscillator signal and the reflected FMCW signal. The frequency difference (i.e., the beat frequency), Δf, between the local oscillator signal and the reflected FMCW signal is obtained directly from the output of the balanced photodetectors 303. The beat frequency Δf can then be used to estimate range to the target, R, and the radial velocity, vᵣ, of the target using Equations [1] and [2], respectively.

$$R = \frac{Δ f \times c \times T}{BW} , \qquad [ 1 ]$$

where Δf is the frequency difference between the emitted and reflected FMCW signals, c is the speed of light, T is the frequency sweep time, and BW is the frequency sweep bandwidth, and

$${v}_{r} = \frac{{f}_{D} \times c}{2 {f}_{0}} , \qquad [ 2 ]$$

where f_{D} is the Doppler frequency provided by the FMCW sensor, and f₀ is the transmission frequency of the emitted FMCW signal. The Doppler frequency, f_{D}, can be determined by applying a second FFT to each range cell, to produce a 2D complex valued spectrum, whose amplitude corresponds to the Doppler shift of the moving target.

In the disclosed embodiments, range and radial velocity are not used to detect a tap gesture. The measured signal after balanced photodiodes 303 is given by:

$$y ( t ) = {A}_{R} exp [ j \{ 2 {πγτ}_{D} t + 2 π {f}_{0} {τ}_{D} + {πγτ}_{D}^{2} + Δϕ ( t ) \} ] , \qquad [ 3 ]$$

where the first term 2πγτ_{D}t is the beat note, the second term 2πf₀τ_{D} is the beat signal phase, φ_{b}(t), the third term is small and therefore negligible and the fourth term is the change in carrier phase. The beat signal phase, φ_{b}(t), can be rewritten as follows:

$${ϕ}_{b} ( t ) : = 2 π {f}_{0} {τ}_{D} = \frac{2 π c}{λ} \times \frac{2 R}{c} = \frac{4 π R}{λ} , \qquad [ 4 ]$$

where τ_{D} is the return time of the reflected FMCW signal

$$( {τ}_{D} = \frac{2 R}{c} ) ,$$

f₀ is the transmission frequency, R is the range to the target, c is the speed of light and Δ is wavelength of the emitted FMCW signal.

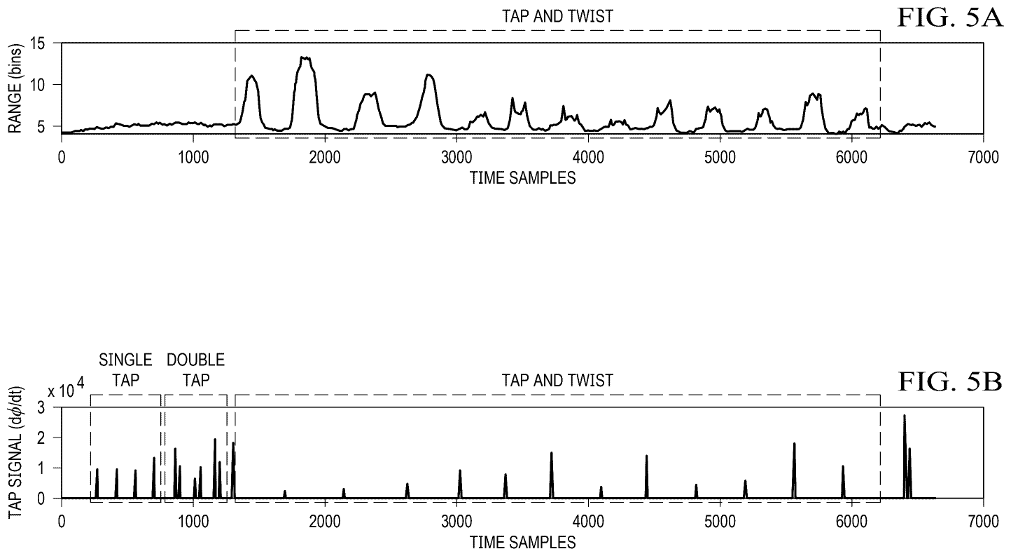

Accordingly, a tap gesture can be detected by detecting a sudden shift in, dφ_{b}(t)/dt, as shown in FIG. 5B. Due to the high resolution of the detection (e.g., fractions of a wavelength), even if the reflection points are not on the user's fingers (e.g., on the user's palm or wrist) the phase shift can be detected due to the “shake” of the user's palm or wrist when the user's forefinger and thumb make physical contact.

FIG. 4A is an example time-frequency plot (spectrogram) of complex-valued coefficients, according to one or more embodiments. The vertical axis is frequency bins and the horizontal axis is time samples. The phase tracking process 202 described above searches through the delta phase values in all frequency bins (columns of 2D array) for each time sample. The delta phase shifts that meet or exceed a threshold value are detected and extracted. Also, the direction (up, down, left, right) that the window will move over the array next is determined so as to follow the direction of maximum phase values over time. In the example shown, the signal 401 is the extracted maximum delta phase shift signal across all the frequency bins (a column in the 2D array) for multiple time samples, resulting in a maximum phase shift signal as illustrated in FIG. 4B.

FIGS. 5A and 5B show raw data to illustrate the concepts described in reference to FIG. 2. The top plot is range (bins) versus time and the bottom plot is tap signal versus time. Note that the tap signal is the change in the beat signal phase over time when the user's thumb and forefinger make contact, as described in reference to FIGS. 2 and 4. High-pass filtered single tap and double tap signals are shown in FIG. 5B. A tap and twist gesture results in a range (bin) fluctuation as shown in FIG. 5A. Thus, these plots illustrate how tap and twist gestures can be detected in a reflected FMCW signal. Notice in FIG. 5A the clear fluctuations in the range that are indicative of a twist gesture.

FIG. 6 illustrates how a twist gesture can be detected, in accordance with one or more embodiments. In some embodiment, the twist motion is detected based on a difference in range, δ, given by Equations [5]-[7] derived from the geometry shown in FIG. 6:

$${v}_{1} = ω {r}_{1} ; {v}_{2} = ω {r}_{2} ; \qquad [ 5 ]$$

$${v}_{1} - {v}_{2} = ω ( {r}_{1} - {r}_{2} ) = ω \sqrt{{d}_{1}^{2} + {d}_{2}^{2} - 2 {d}_{1} {d}_{2} cos ( θ )} , \qquad [ 6 ]$$

$$δ = \sqrt{{d}_{1}^{2} + {d}_{2}^{2} - 2 {d}_{1} {d}_{2} cos ( θ )} , \qquad [ 7 ]$$

where v₁ is the measured radial velocity of a first point painted on the target, v₂ is the radial velocity of a second point painted on the target, d₁ is the range to the first point, d₂ is the range to the second point on the target, and θ is the twist angle between d₁ and d₂ as shown in FIG. 6 (assuming a rigid body from the user's elbow to their hand). The ranges and radial velocities are computed from Equations [1] and [2] and the ranges subtracted to get the difference range, δ. Equation [7] can then be used to solve for the twist angle, θ, where the sign of θ determines the direction of rotation, i.e., clockwise or counterclockwise.

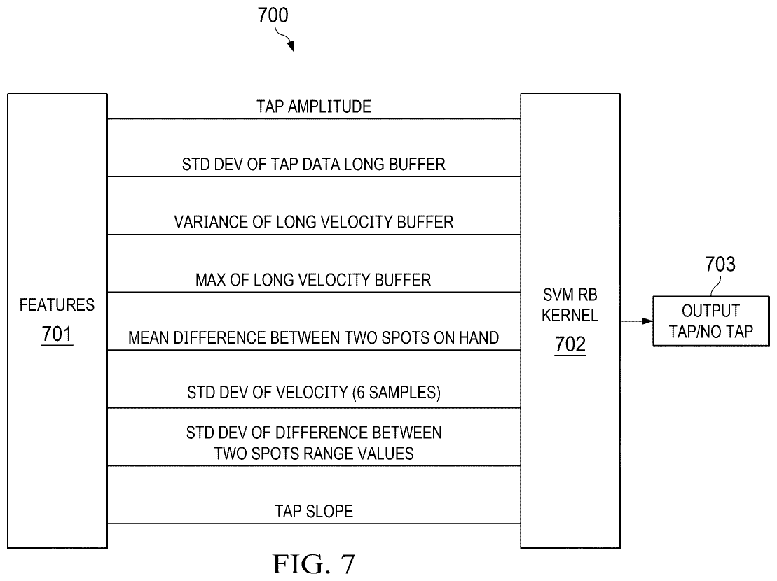

FIG. 7 illustrates using a machine learning model 700 to predict tap or no tap classes based on various features 701 to mitigate false positives, according to one or more embodiments. In some embodiments, the features include but are not limited to: tap amplitude, standard deviation (Std) of tap data stored in a long term buffer, variance of radial velocity stored in a long term buffer, maximum radial velocity stored in a long term buffer, maximum difference, δ, between two reflection spots on the hand (FIG. 6), the Std of radial velocity (e.g., 6 samples) and the slope of the tap signal shown in FIG. 6. Two or more of these features are input into a machine learning model (e.g., a support vector machine (SVM)) which outputs tap or no tap classes. Thus, in some embodiments machine learning can be used to mitigate false positives.

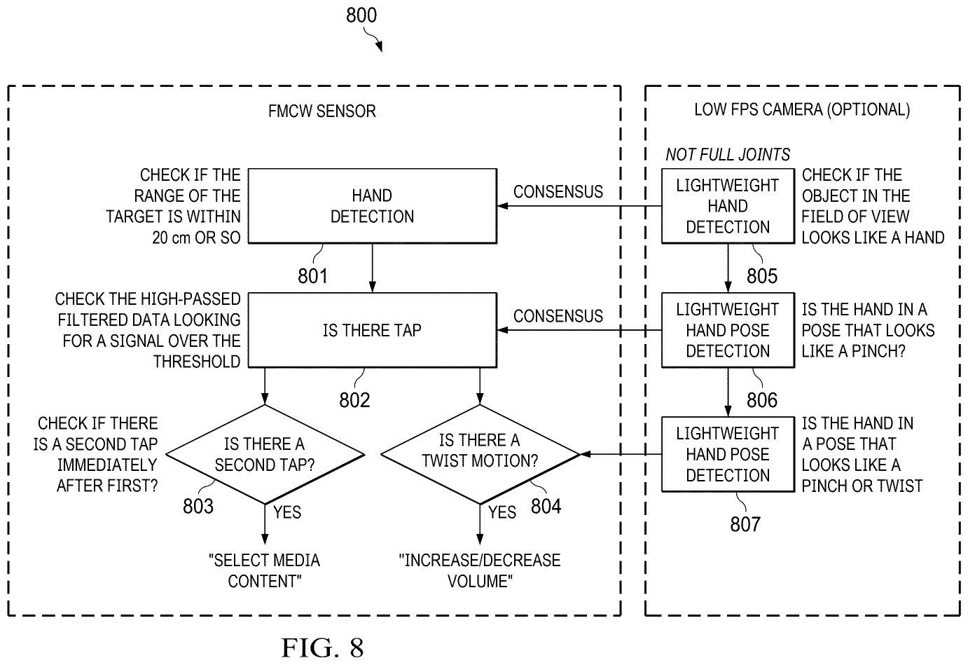

FIG. 8 illustrates a process 800 for controlling operations of a device based on detected gestures, according to one or more embodiments. Process 800 begins with hand detection 801 by checking if the range of the target (e.g., hand) is with x centimeters (e.g., 20 cm) of the FMCW sensor 801. Process 800 continues by determining if there is a tap 802 by checking the high-pass filtered phase data for a peak over a specified threshold 802 (maximum phase shift), as described in reference to FIG. 2. Process 800 continues by determining if there is a second tap 803 or a twist motion 804. If there is a second tap immediately after the first tap, then process 800 performs an operation on the wearable device (e.g., select new media content). If there is a twist motion following immediately after the first tap, then process 800 performs a different operation on the wearable device (e.g., increase/decrease volume).

In some embodiments, an optional low frame rate camera can provide confidence checks. For example, the camera can perform lightweight hand detection 805 (not full joints) to check if the object in the field of view looks like a hand. Lightweight pose detection 806 can determine if the hand is in a pose that looks like a pinch. Lightweight hand pose detection 807 can also be used to determine if the hand is in a pose that looks like a pinch and twist. Accordingly, lightweight camera data can optionally be used with the FMCW sensor data to detect single tap, double tap and twist gestures, and in response provide control of one or more operations for the wearable device.

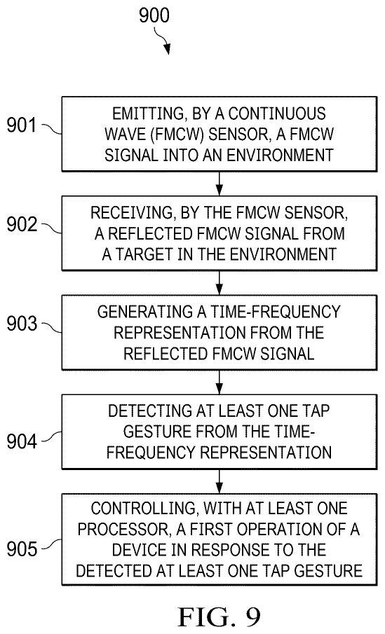

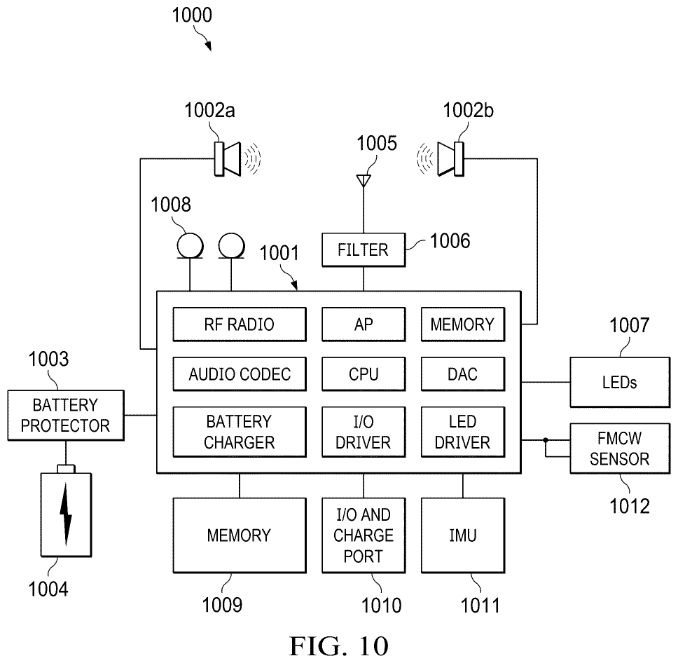

FIG. 9 illustrates a process of low power gesture detection using FMCW signals, according to one or more embodiments. Process 900 can be implemented using, for example, the device architecture 1000 of FIG. 10.

Process 900 includes emitting, by a frequency modulated continuous wave (FMCW) sensor, an FMCW signal into an environment (901), receiving, by the FMCW sensor, a reflected FMCW signal from a target in the environment (902), processing, by the FMCW sensor, the reflected FMCW signal by: generating a time-frequency representation of the reflected FMCW signal (903), detecting at least one tap gesture from the time-frequency representation (904), controlling, with at least one processor, a first operation of a device in response to the detected at least one tap gesture (905). In some embodiments, the process 900 includes detecting a twist gesture from the time-frequency representation; and controlling, with the at least one processor, a second operation of the device in response to the detected twist gesture. In some embodiments, a double-tap gesture or combined tap and twist gesture are detected.

### Example Device Architecture

FIG. 10 is a conceptual block diagram of device architecture 1000 implementing the features and operations described in reference to FIGS. 1-9. In an embodiment, architecture 1000 can includes system-on-chip (SoC) 1001, stereo loudspeakers 1002a, 1002b (e.g., ear devices or speakers), battery protector 1003, rechargeable battery 1004, antenna 1005, filter 1006, LEDs 1007, microphones 1008, memory 1009 (e.g., flash memory), I/O/Charge port 1010, IMU 1011 which includes, for example, a 3-axis MEMS gyro and a 3-axis MEMS accelerometer, and FMCW sensor 1012 for implementing the architectures shown in FIG. 3.

SoC 1001 further includes various modules, such as a radio frequency (RF) radio (wireless transceiver) for wireless bi-directional communication with other devices, such as a smartphone, tablet computer, AR/VR googles//glasses, etc. SoC 1001 further includes an application processor (AP) for running specific applications, memory (e.g., flash memory), central processing unit (CPU) for managing various functions of the wearable device, audio and video codecs for encoding/decoding audio and video, respectively, battery charger for charging/recharging rechargeable battery 1004, I/O driver for driving I/O and charge port (e.g., a micro USB port), digital to analog converter (DAC) converting digital audio into analog audio and LED driver for driving LEDs 1007 and implementing the FMCW gesture detection on reflected signals received by FMCW sensor 1012, as described in reference to FIGS. 1-9. Other embodiments can have more or fewer components.

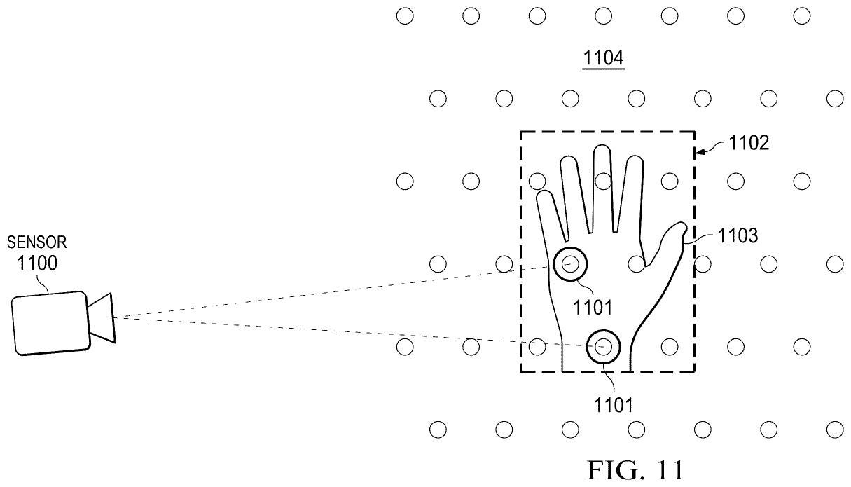

FIG. 11 illustrates an alternative process for low power gesture detection using FMCW signals, according to one or more embodiments. FMCW sensor 1100 emits FMCW signals 1101 with a high duty cycle in sensor field of view (FOV) 1102 to detect contact with hand 1103. Additionally, FMCW sensor 1100 emits FMCW signals 1104 with a lower duty cycle for detecting course gestures which is defined as a relative motion between fingers.

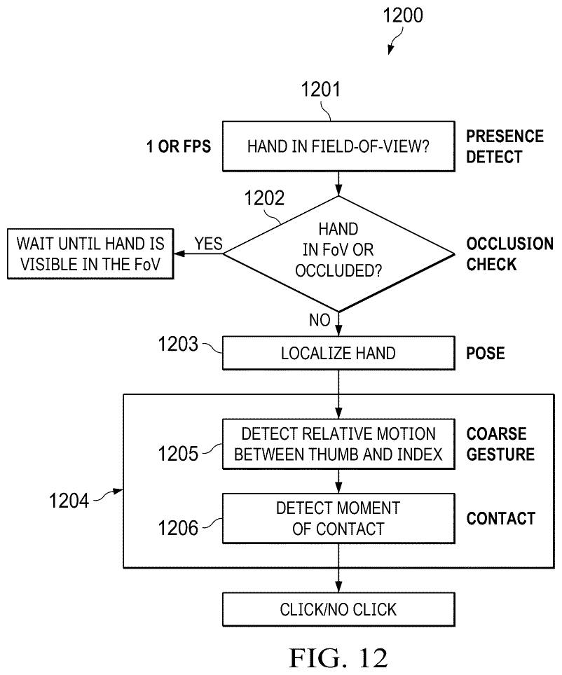

FIG. 12 is a flow diagram of the alternative process illustrated in FIG. 11. Process 1200 begins by detecting the presence 1201 of hand 1103 in FOV 1102, followed by occlusion check 1202 to determine if hand 1103 is occluded by another object. If hand 1103 is occluded, process 1200 waits until hand 1103 is visible in FOV 1102. If hand 1103 is not occluded, the pose of hand 1103 is localized 1203 in FOV 1102. After the pose is localized, machine learning model 1204 processes the localized hand data using course gesture detection 1205 to detect relative motion 1203 between fingers of hand 1103, such as the thumb and index fingers, and moment of contact detection 1206 to detect contact (tap) between two fingers, and outputs a decision. In some embodiments, machine learning 1204 is implemented with a transformer-based network with two independent prediction heads: one for coarse gesture detection 1205 and one for contact detection 1206.

In some embodiments, the transformer-based network includes a tokenizer, which converts input data into a sequence of tokens. In some embodiments, tap amplitude, standard deviation (Std) of tap data stored in a long term buffer, variance of radial velocity stored in a long term buffer, maximum radial velocity stored in a long term buffer, maximum difference, δ, between two reflection spots on the hand (FIG. 11), the Std of radial velocity (e.g., 6 samples) and the slope of the tap signal, and a break signature can be encoded into a token sequence for input into the transformer.

In some embodiment, the transformer network also includes an embedding layer, which converts the tokens and their positions in the sequence into vector representations, an encoder transformer layer comprising alternating attention and feedforward layers which perform iterative transformations on the vector representations to extract increasingly more complex and nuanced information from the vector representations, and an un-embedding layer, which converts the final vector representations back to a probability distribution over the tokens. The output of the transformer is coupled to two prediction heads (e.g., neural networks) which are trained to predict coarse gestures and contacts/taps, respectively.

By changing the bandpass frequencies of the FMCW signals and combining them with the coarse gesture signals 1102, a signature of a “break” can be detected, which allows detection of gestures that include breaks, such as pinch and drag gestures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method comprising:
emitting, by a continuous wave (FMCW) sensor, a FMCW signal into an environment;
receiving, by the FMCW sensor, a reflected FMCW signal from a target in the environment;
processing, by the FMCW sensor, the reflected FMCW signal by:
generating a time-frequency representation from the reflected FMCW signal;
detecting at least one tap gesture from the time-frequency representation; and
controlling, with at least one processor, a first operation of a device in response to the detected at least one tap gesture.

2. The method of claim 1, wherein detecting at least one tap gesture from the time-frequency representation, further comprises:
determining a rate of change of a beat signal phase over time from the time-frequency representation;
detecting a shift in the rate of change of the beat signal phase over time;
comparing the shift to a threshold; and
detecting the at least one tap gesture based on a result of the comparing.

3. The method of claim 1, wherein processing the reflected FMCW signal further comprises:
detecting a twist gesture from the time-frequency representation; and
controlling, with the at least one processor, a second operation of the device in response to the detected twist gesture.

4. The method of claim 3, wherein detecting a twist gesture from the time-frequency representation further comprises:
detecting ranges of the target from the time-frequency representation;
detecting a change in the range over time;
comparing the change to a threshold; and
detecting the twist gesture based on a result of the comparing.

5. The method of claim 4 further comprising:
detecting if a hand is within a threshold distance of the FMCW sensor;
responsive to the hand being within a threshold distance of the FMCW sensor,
detecting a first tap gesture;
detecting a second gesture following the first tap gesture;
responsive to the second gesture being another tap gesture, performing the first operation of the device; and
responsive to the second gesture being a twist motion, performing the second on operation of the device.

6. The method of claim 5, wherein the device includes a media player and the first operation selects audio content for playback on the device, and the second operation changes a volume of the audio content during the playback.

7. A system comprising:
a frequency modulated continuous wave (FMCW) sensor configured to emit a FMCW signal into an environment, receive a reflected FMCW signal from a target in the environment, generate a time-frequency representation from the reflected FMCW signal, detect at least one tap gesture from the time-frequency representation; and
at least one processor configured to perform a first operation of a device in response to the detected at least one tap gesture.

8. The system of claim 7, wherein detecting at least one tap gesture from the time-frequency representation, further comprises:
determining a rate of change of a beat signal phase over time from the time-frequency spectrum;
detecting a shift in the rate of change of the beat signal phase over time;
comparing the shift to a threshold; and
detecting the at least one tap gesture based on a result of the comparing.

9. The system of claim 7, wherein the FMCW sensor is further configured to detect a twist gesture from the time-frequency representation and control a second operation of the device in response to the detected twist gesture.

10. The system of claim 9, wherein detecting a twist gesture from the time-frequency representation further comprises:
detecting ranges of the target from the time-frequency representation;
detecting a change in the range over time;
comparing the change to a threshold; and
detecting the twist gesture based on a result of the comparing.

11. The system of claim 9 further comprising:
detecting if a hand is within a threshold distance of the FMCW sensor;
responsive to the hand being within a threshold distance of the FMCW sensor,
detecting a first tap gesture;
detecting a second gesture following the first tap gesture;
responsive to the second gesture being another tap gesture, performing the first operation of the device; and
responsive to the second gesture being a twist motion, performing the second operation of the device.

12. The system of claim 11, wherein the device includes a media player and the first operation selects audio content for playback on the device, and the second operation changes a volume of the audio content during the playback.

13. A method comprising:
emitting, by a continuous wave (FMCW) sensor, a FMCW signal into an environment;
receiving, by the FMCW sensor, a reflected FMCW signal from a target in the environment;
processing, by the FMCW sensor, the reflected FMCW signal by:
detecting the presence of a hand in a field of view (FOV) of the FMCW sensor;
localizing the hand in the FOV;
detecting, with a transformer-based network, relative motion between fingers of the hand;
detecting, with the transformer-based network, a tap between the fingers;
determining, with at least one processor, a gesture based on the detected relative motion and tap; and
determining, with the at least one processor, a first operation of a device in response to the detected gesture.
